(19) United States
(12) Patent Application Publication
(10) Pub. No.: US 2006/0086765 A1
(43) Pub. Date: Apr. 27, 2006

(54) Sealing member for attachment components

(75) Inventors: John H. Harberts, Macomb, MI (US); Ronald G. Saward, Shelby Township, MI (US); Steven Ploucha, Sterling Heights, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: SportRack LLC

(21) Appl. No.: 10/974,242

(22) Filed: Oct. 27, 2004

(51) Int. Cl. B60R 9/04

(52) U.S. Cl. 224/309

(57) ABSTRACT

The embodiments described herein provide a sealing member and exemplary methods for preventing fluid leaks into a mating body when a low-compression fastener is used by providing a barrier between two mating surfaces. The sealing member comprises a generally ring-shaped body having elastic properties including an upper surface and a lower surface. At least one upper bead is disposed on the upper surface. At least one lower bead is disposed on the lower surface.

### FIELD OF THE INVENTION

The present invention relates to improvements in sealing technology. More particularly, the present invention relates to an improved sealing structure for preventing fluid leaks into a vehicle compartment by providing a barrier between an article carrier and a vehicle outer surface when a low-compression fastener is used.

### BACKGROUND

Typical mating sealing areas employ rubber or elastomer sealing barriers in the form of an O-ring or a gasket, the rubber or elastomer seal being compressed to a specific degree by a conventional fastener to prevent fluid or contaminants from leaking into a mating body such as a vehicle compartment. The conventional fastener is tightened to provide sealing as a result of the stress of the seal between two mating components. The sealing barriers are more specifically used between a roof rack or an article carrier and a vehicle outer surface. The article carrier is typically mounted onto the vehicle outer surface and secured by conventional fasteners. A conventional compressible seal or gasket is used between the article carrier and the vehicle outer surface providing the sealing barrier between the article carrier bottom surface and the vehicle outer surface.

A conventional compressible seal or gasket is used to seal the vehicle compartment when the article carrier is attached to the vehicle outer surface. There is no surface-to-surface contact between the article carrier bottom surface and the vehicle outer surface at an article carrier mounting point. An aperture in the vehicle outer surface provides the mounting point for the article carrier allowing a user to attach the article carrier to the vehicle outer surface using the conventional fastener. A vehicle needs apertures in the vehicle outer surface to receive the article carrier. The seal or gasket bears the entire load of the conventional fastener and the article carrier. Over time, there is often additional compression of the seal or gasket as a result of the loads and tensile forces on the seal or gasket. This compression results in a loss of stretch or compressibility in the seal or gasket, further resulting in a loss of torque-tension in the conventional fastener. The loss of torque-tension is responsible for gaps between the sealing member and the vehicle outer surface allowing fluid leaks into the vehicle compartment. To compensate for the diminishing of the potential energy in the conventional fasteners, such a fastener is normally assembled with enough of a load on the seal or gasket body to make the torque-tension losses insignificant. Unfortunately, applying additional torque-tension to the conventional fastener often causes the article carrier to be damaged.

Ordinary O-rings and gaskets are typically used as seals in mounting of article carriers on vehicle outer surfaces. The seals are placed between the carrier rack and the vehicle surface, whereby the carrier rack sits on the seals. Typical O-rings and gaskets distribute surface pressure unevenly because of material variations within the seal itself. In addition to the material variations in the sealing body of the O-ring or gasket, vehicle outer surfaces are typically not level or planar by design and the variations in a surface design must be accommodated by the sealing body. Another consideration when sealing an aperture in the vehicle outer surface is the variation between the bottom surface of the article rack and the outer surface of the vehicle. The two surfaces typically do not mate properly causing variations in the surface-to-surface contact as mentioned above and these variations are not properly addressed by the conventional O-ring and gasket. Finally, the small relative movements and inherent tensile stress between the article rack and the vehicle outer surface caused by vehicle vibrations and wind against the article carrier also result in the failure of the O-ring and gasket seal.

To overcome the shortcomings, it has been known to use high-compression fasteners. However, such fasteners have an unfavorable effect on the useful lifespan of the seal.

There has therefore been a need for a seal having a high degree of flexibility and elasticity that prevents fluid and various contaminant leaks into a vehicle compartment by providing a barrier between the article carrier bottom surface and the vehicle outer surface when a low-compression fastener is used.

### SUMMARY

The embodiments described herein provide a solution to known problems in the prior art with an innovative sealing member for preventing fluid and contaminant leaks into the vehicle compartment when a low-compression fastener is used. The sealing member acts as a sealing barrier between the article carrier bottom surface and the vehicle outer surface. The sealing member provides proper sealing for the vehicle compartment despite the vehicle outer surface or the article carrier bottom surface being uneven, rounded, or non-planer. The article rack bottom surface may not align with the vehicle outer surface onto which the article carrier is attached and secured to, but proper sealing of the vehicle compartment by the innovative sealing member is still provided.

In one embodiment, the sealing member includes a sealing body, an upper surface, a bottom surface, an inner periphery, and an outer periphery. It is contemplated that the shape of the sealing member in the planer view includes: a generally round, a generally rectangular, a generally oval, and a generally square shape. At least one upper sealing bead is disposed on the upper surface extending away from the upper surface and at least one lower sealing bead is disposed on the lower surface extending away from the lower surface. A sealing assembly includes the low-compression fastener and the sealing member, which are disposed between the article carrier bottom surface and the vehicle outer surface securing the article carrier onto the vehicle. The sealing assembly may also be secured anywhere along the vehicle outer surface adapted to receive the article carrier. The sealing member is not subject to the kind of excessive heat found in an engine manifold during operation.

During operation in accordance with one embodiment, a user installs the sealing assembly by placing the sealing member between the article carrier bottom surface and the vehicle outer surface. Alternatively, the sealing member is placed between a low-compression fastener and the vehicle outer surface for proper sealing of the aperture in the vehicle outer surface. Here, an aperture in the sealing member is aligned with the aperture in the vehicle outer surface. The low-compression fastener is then inserted through the aperture of the sealing member and through the aperture in the vehicle surface until it is secured to the vehicle surface. The low-compression fastener is secured to the vehicle surface once it is selectively moved into a secured position with the vehicle surface. The article carrier may be secured to the low-compression fastener prior to securement of the fastener to the vehicle or may be secured to the fastener after securement of the low-compression fastener to the vehicle.

### BRIEF DESCRIPTION OF THE DRAWINGS

The features and inventive aspects of the present invention will become more apparent upon reading the following detailed description, claims, and drawings, of which the following is a brief description:

FIG. 1 is a top plan view of a sealing member according to a first embodiment of the invention.

FIG. 2 is a bottom plan view of the sealing member of FIG. 1.

FIG. 3 is a diametrical sectional view of the sealing member of FIG. 1, taken along line A-A of FIG. 1.

FIG. 4 is a diametrical sectional view of a sealing member according to a second embodiment of the invention taken along line A-A of FIG. 1.

FIG. 5 is a vertical sectional view of the sealing member of FIG. 1, taken along line A-A of FIG. 1 showing the sealing member, a mating component, a mating surface, and a low-compression fastener.

FIG. 6 is a transverse sectional view of the sealing member of FIG. 5, showing the sealing member, the low-compression fastener, and the mating surface.

### DETAILED DESCRIPTION

Referring now to the drawings, preferred illustrative embodiments of the present invention are presented. Although the drawings represent embodiments of the present invention, the drawings are not necessarily to scale and certain features may be exaggerated to better illustrate and explain the present invention. Further, the embodiments set forth herein are not intended to be exhaustive or otherwise limit or restrict the invention to the precise forms and configurations shown in the drawings and disclosed in the following detailed description.

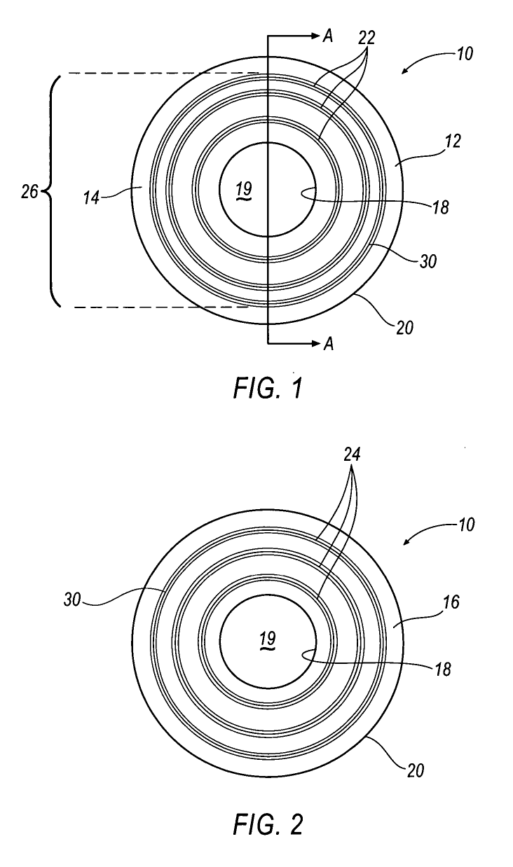

The illustrated embodiments shown in FIGS. 1-6 are directed to an innovative sealing member for preventing fluid leaks into a vehicle compartment when a low-compression fastener is used. The sealing member acts as a sealing barrier between the article carrier bottom surface and the vehicle outer surface. The sealing member provides proper sealing for the vehicle compartment despite the vehicle outer surface or the article carrier bottom surface being uneven, rounded, or non-planer. The article rack bottom surface may not align with the vehicle outer surface onto which the article carrier is attached and secured to but proper sealing of the vehicle component by the innovative sealing member is still provided.

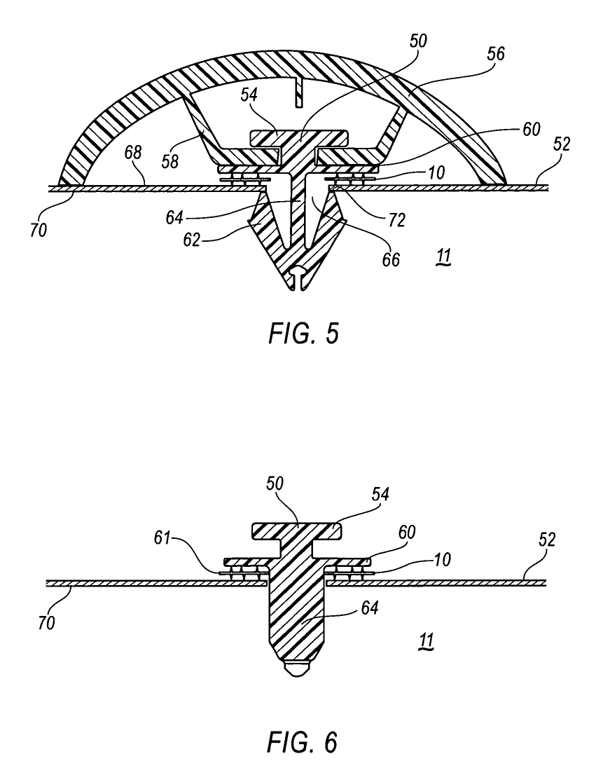

As best shown in FIGS. 1, 2, and 3, a first embodiment of a sealing member 10 includes a body 12, an upper surface 14, a lower surface 16, an inner periphery 18, and an outer periphery 20. The inner periphery 18 defines an aperture 19. While the shape of the sealing member 10 in the plan view as shown in FIG. 1 has a generally round shape, it is contemplated that the member may be one of a wide variety of geometric shapes including a generally rectangular, a generally oval, a generally square. At least one upper sealing bead 22 is disposed on the upper surface 14 extending away from the upper surface 14 and at least one lower sealing bead 24 is disposed on the lower surface 16 extending away from the lower surface 16. The upper sealing bead 22 and the lower sealing bead 24 are disposed generally continuously and circumferentially around the body 12. The sealing member 10 is suitable for use in a variety of applications, and specifically when proper sealing is desired when using a low-compression fastener 50 as shown in FIG. 5.

Fortunately, as will be evident from the following description, the sealing member 10 of the illustrated embodiments is fully adaptable to such customizing. The term sealing member 10 is intended to encompass any gasket or sealing apparatus, which is molded or otherwise formed into a continuous ring of whatever circumferential shape or cross-sectional shape, primarily designed for, but not limited to, fitting around a low compression fastener 50 for sealing between the article carrier 56 and the vehicle outside surface 52 as shown in FIG. 5. Other beneficial uses of the sealing member 10 include as a sealant between faces or raised face surfaces where no surface-to-surface contact is desired.

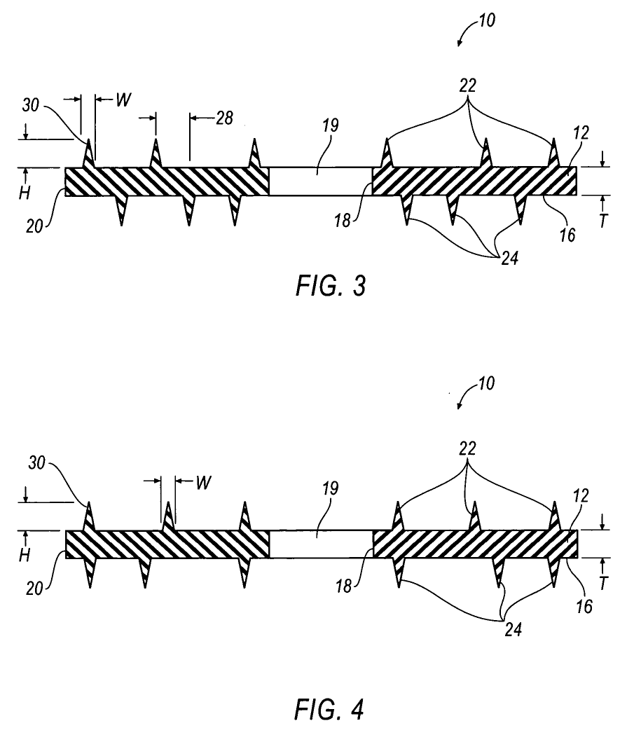

FIGS. 1-3 show the sealing member 10 as generally ring-shaped comprising the body 12 defining the aperture 19. It is contemplated that the sealing member 10 may be formed from any one or more of the following elastic materials: rubber, an elastomer, a polyamide resin, nylon, plastic, and a thermoplastic elastomer including Santopreme 45 durometer rubber. The term “elastic” includes properties associated with the above mentioned materials. FIG. 3 shows the first embodiment with an upper sealing bead 22 on the upper surface 14 of the body 12 offset from a corresponding lower sealing bead 24 on the lower surface 16 of the body 12. As shown by bead offset 28, the offset of the upper sealing bead 22 from the lower sealing bead 24 provides an even sealing pressure pattern by distributing a load among a overall bead area 26 (see FIG. 1).

Thus, load shifting minimizes the likelihood of premature cracking, failure, or leaking by properly distributing the load along the bead area 26 where the load is desired.

Pressure may also be controlled by adjusting a height H and a width W of either the upper sealing bead 22 or lower sealing bead 24 relative to a thickness T of the body 12. In a preferred embodiment as shown in FIGS. 3 and 4, the height H of either the upper sealing bead 22 or the lower sealing bead 24 is greater than the thickness T of the body 12. It is contemplated that the height H of either the upper sealing bead 22 or the lower sealing bead 24 may be less than the thickness T of the body 12. The smaller the bead offset 28 between the upper sealing bead 22 and the lower sealing bead 24, the greater the sealing pressure at the upper sealing bead 22 and the lower sealing bead 24. Pressure at the upper sealing bead 22 and the lower sealing bead 24 is maximized when the bead offset 28 is zero as shown in FIG. 4 at the aligned beads disposed proximate the inner periphery 18 and outer periphery 20. The uniform load applied to the bead area 26 by the low-compression fastener 50 is further discussed below. The upper sealing bead 22 and the lower sealing bead 24 are shown to be generally triangular in cross-section. It is contemplated that the cross-section of the upper sealing bead 22 and lower sealing bead 24 is not limited to a triangular shape but may define various other shapes including: a generally round, a generally square, and a generally oval shape.

Referring to FIG. 4, a second embodiment is illustrated having at least one upper sealing bead 22 aligned with a corresponding lower sealing bead 24 providing more sealing pressure at the aligned beads. It may be desirable to have more sealing pressure at the outer sealing bead 30 for preventing fluids and contaminants from reaching the aperture 19. It is contemplated that the aligned upper sealing bead 22 and the lower sealing bead 24 may be disposed circumferentially anywhere along the upper surface 14 or the lower surface 16 of the sealing member 10 where a greater sealing pressure is desired. It is also contemplated that at least one upper sealing bead 22 is offset from one lower sealing bead 24 for proper load distribution, minimizing the likelihood of premature cracking, failure, or leaking.

Referring to FIG. 5, the sealing member 10 is shown in a secured orientation disposed between a low-compression fastener 50 and a vehicle outside surface 52. The low-compression fastener 50 includes a fastener head 54 for securing the article carrier 56 to the vehicle outside surface 52. The sealing member 10 is not limited for use on a vehicle outside surface 52, but may include any surface where two mating components are to be secured by a conventional low-compression fastener 50. The low-compression fastener 50 does not require an operation that further tightens and produces higher compression. For example, a screwing operation further tightens a fastener after installation allowing higher compression between the article carrier 56 and the vehicle outside surface 52. The low-compression fastener 50 requires no additional turning operation by the user in order to provide additional torque-tension between the low-compression fastener 50 and the vehicle outside surface 52. The low-compression faster provides a predetermined tension and may not be manually adjusted by the user.

The low-compression fastener 50 is attached to the article carrier 56 by an article carrier securing member 58 of the article carrier 56; however, any attachment method for securing the article carrier 56 to the low-compression fastener 50 may be used. An article carrier securing member 58 is secured to the low-compression fastener 50 when it is properly disposed between the fastener head 54 and a fastener plate 60. The fastener plate 60 is disposed between the fastener head 54 and the sealing member 10, providing a load bearing surface 61 for the sealing member 10. The load of the article carrier 56 is transferred to the fastener plate 60 when the article carrier 56 is in a secured orientation as shown in FIG. 5.

The low-compression fastener 50 includes a fastener wing 62 disposed laterally on each of two sides of a fastener stem 64 in the vertical section view shown in FIG. 5. The fastener stem 64 is disposed inside a vehicle surface aperture 66 in the secured orientation as shown in FIG. 5. The vehicle surface aperture 66 is defined by a vehicle outer surface 68 and a vehicle inner surface 70. The vehicle surface aperture 66 is disposed between the vehicle outer surface 68 and the vehicle inner surface 70 and may be located anywhere on the vehicle surface 52 for the proper securement of the article carrier 56. The low-compression fastener 50 is in a secured orientation when the fastener stem 64 is disposed inside the vehicle surface aperture 66 and each fastener wing top surface 72 is in direct contact with the vehicle inner surface 70. The low-compression fastener 50 further secures the article carrier 56 in the secured orientation when the article carrier securing member 58 of the article carrier 56 is disposed between the fastener plate 60 and the fastener head 54.

Low-compression fasteners 50 come in a variety of sizes and shapes, it should be understood that some customizing of the body 12 of the sealing member 10 may be required for proper performance of the sealing member 10 depending on the specific fastener used.

During operation, the user can install the sealing member 10 by placing the sealing member 10 between the article carrier 56 and the vehicle surface 52. In the alternative, the sealing member 10 may be placed between the low-compression fastener 50 and the vehicle surface 52 for proper sealing of the vehicle surface aperture 66. The aperture 19 of the sealing member 10 is aligned with the vehicle surface aperture 52 of the vehicle surface 52. The low-compression fastener 50 is then placed through the aperture 19 of the sealing member 10 and through the vehicle surface aperture 66 of the vehicle surface 52 until it is in the secured orientation as shown in FIG. 5. The article carrier 56 may be secured to the low-compression fastener 50 prior to securement of the low-compression fastener 50 to the vehicle surface 52 or may be secured to the low-compression fastener 50 after securement of the low-compression fastener 50 to the vehicle surface 52.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A sealing member comprising:
a body having elastic properties including an upper surface, a lower surface, an inner periphery, and an outer periphery;
an aperture defined by said inner periphery;
at least one upper bead disposed on said upper surface;
at least one lower bead disposed on said lower surface; and
said upper bead being radially offset from said lower bead;
whereby said sealing member provides a seal between an article carrier and a vehicle outer surface.

2. A sealing member according to claim 1, wherein said body is formed of one of a rubber, a polyamide resin, a nylon, a plastic, and a Santopreme 45 durometer rubber.

3. A sealing member according to claim 1, wherein said body is generally one of an oval, a square, a circle, and a rectangle.

4. A sealing member according to claim 1, wherein said body defines a bead area whereby said bead area is under a load of said article carrier.

5. A sealing member according to claim 1, wherein said upper bead includes an upper bead height greater than a body thickness.

6. A sealing member according to claim 1, wherein a second upper bead is generally aligned with a second lower bead.

7. A sealing member according to claim 1, wherein said upper bead is disposed continuously around said body.

8. A sealing member according to claim 1, wherein said lower bead is disposed continuously around said body.

9. A sealing member according to claim 1, wherein said body provides flexibility to seal said aperture on a non-planar surface of said vehicle outer surface.

10. A sealing assembly for securing an article carrier to a vehicle outside surface comprising:
a fastener having an upper end, a lower end, and a midpoint;
a body having elastic properties including an upper surface, a lower surface, an inner periphery, and an outer periphery, said body is adapted to be engaged with said fastener;
at least one upper bead disposed on said upper surface; and
at least one lower bead disposed on said lower surface, said lower bead being radially offset from said upper bead;
whereby said upper end selectively engages said article carrier, said lower end selectively engages said vehicle outside surface, and said body provides flexibility to seal an aperture on said vehicle outer surface.

11. A sealing assembly according to claim 10, wherein said body is formed from one of a rubber, a polyamide resin, a nylon, a plastic, and a Santopreme 45 durometer rubber.

12. A sealing assembly according to claim 10, wherein said body is generally one of an oval, a square, a circle, and a rectangle.

13. A sealing assembly according to claim 10, wherein said body defines a bead area whereby said bead area is under a load of said article carrier.

14. A sealing assembly according to claim 10, wherein said upper bead includes an upper bead height greater than a body thickness.

15. A sealing assembly according to claim 10, wherein a second upper bead is generally aligned with a second lower bead.

16. A sealing assembly according to claim 10, wherein said upper bead and said lower bead are disposed continuously around said body.

17. A sealing assembly according to claim 10, wherein said body provides flexibility to seal said aperture on a non-planar surface of said vehicle outer surface.

18. A sealing assembly according to claim 10, wherein said fastener is a low-compression fastener having a predetermined torque that does not require an additional torque operation by a user.

19. A method of sealing an aperture in a vehicle surface comprising the steps of:
placing a sealing member between a vehicle surface and an article carrier;
securing said article carrier onto said vehicle outside surface using a low-compression fastener;
pushing said fastener into an aperture disposed on said vehicle outside surface for said securing; and
whereby said sealing member prevents fluid leaking into a vehicle compartment when securing said article carrier onto said vehicle outside surface.

20. The method of claim 19, wherein said securing includes attaching said low-compression fastener to said article carrier, said fastener having a predetermined torque for securement.
